(19) United States
(12) Patent Application Publication
(10) Pub. No.: US 2018/0153767 A1
(43) Pub. Date: Jun. 7, 2018

(54) WARM BATH DEVICE, WARM BATH METHOD, AND PLATE BODY

(71) Applicant: Tokyo Gaten Corporation, Tokyo (JP)

(72) Inventors: Yoshinori MAEDA, Tokyo (JP); Hidemine YAMAGUCHI, Tokyo (JP)

(73) Assignee: Tokyo Gaten Corporation, Tokyo (JP)

(21) Appl. No.: 15/575,453

(22) PCT Filed: Jul. 24, 2015
(86) PCT No.: PCT/JP2015/071122

§ 371 Date: Nov. 20, 2017

(51) Int. Cl. A61H 33/06

(52) U.S. Cl. CPC A61H 33/06; E04F 15/02; A61H 2033/061; A61H 2201/0207

(57) ABSTRACT

Provided is a technique which can be used to provide a service with a higher health promoting effect than conventional ceramic plate baths. In a warm bath system 1, a warm bath device 10 is installed in a service providing space 5. A housing 400 of the warm bath device 10 accommodates a tatami mat 100, a heating sheet 200, an insulation member 300 with a surface layer member 110 of the tatami mat 100 being exposed from an opening 410. A core 120 of the tatami mat 100 contains a liquid that includes multiple types of predetermined bacteria. The warm bath device 10 warms the tatami mat 100 with the heat from the heating sheet 200 and promotes release of the bacteria outside of the core 120. By using this warm bath device 10, the user's body is warmed and the released multiple types of predetermined bacteria are introduced into the user's body.

### TECHNICAL FIELD

The present invention relates to a warm bath device, a warm bath method using the warm bath device, and a plate body which is usable for the warm bath device.

### BACKGROUND ART

As an example of a mixed bathing service, there is a ceramic plate bath. In the ceramic plate bath, a bathroom in which the temperature of the room is maintained at a predetermined temperature is used. An antioxidant-treated porcelain board is attached to the floor and the wall in this bathroom. In the ceramic plate bath, you lay your body on the floor on this bathroom so that the core of your body is warmed. It is said that this can increase immunity and natural healing power.

### PRIOR ART DOCUMENT

### Patent Document

Patent Document 1: Japanese Patent Application Laid-Open No. 6-330606

### SUMMARY OF THE INVENTION

### Problem to be Solved by the Invention

In the ceramic plate bath, warming the body is able to enhance immunity and natural healing power of the body. However, user tends to desire higher health benefits services than the ceramic plate bath.

The present invention has been considered in the background of the above circumstances, and an object thereof is to provide techniques available to provide higher health benefits service than conventional ceramic plate bath.

### Means for Solving the Problem

The present invention provides a warm bath device comprising a plate body having a plate-like core member and a sheet-like surface layer member, the core member containing a liquid containing multiple types of predetermined bacteria, the surface layer member having air permeability and covering a surface of the core member, and a heat generating sheet functioning as a heat source and disposed on another surface opposite to the surface of the core member covered with the surface layer member.

According to the present invention, the plate body is heated by the heat generating sheet. Warming of the core member of the plate body promotes evaporation of a liquid containing multiple predetermined types of bacteria. The evaporation of the liquid promotes release of the bacteria included in the liquid out of the core member. Released, these bacteria are carried out of the warm bath device through the surface layer member. The bacteria diffuse out of the warm bath device. The diffused bacteria are incorporated into the human body of the person in the vicinity of the warm bath device by the peeson's breath. Further, by the heat of the heat generating sheet, the human body of the person in the vicinity of the warm bath device is warmed. In this manner, in the warm bath device, it is possible to promote release of multiple predetermined types of bacteria out of the warm bath device and diffusion outside the warm bath device while warming the human body.

Using, as a plurality of types of predetermined bacteria, bacteria such as lactic acid bacteria which are expected to provide bacterial health benefits makes it possible to obtain the effect by the action of bacteria (e.g., intestines effect) in addition to improvement of the blood circulation and lymph flow due to warm bath effect (i.e., the effect of warming the body). Therefore, high health benefits as compared to a mere warm bath effect are obtained. In this way, the state in which the flow of blood and lymph is improved and the function of the internal organs is improved by the intestinal effect is expressed in Oriental medicine as “a state in which the general feelings are good”.

In Patent Document 1, tatami having odoriferous in which particles having supported thereon a perfume are embedded therein is disclosed. Fine particles supported on tatami are inorganic porous micro particles or inorganic porous hollow particles in which perfume can evaporate at all times. In contrast, a warm bath device of the present invention includes a plate body. The plate body has a core member comprising a liquid containing multiple types of predetermined bacteria. That is, the object to be included in the plate body (tatami in Patent Document 1) is a perfume in Patent Document 1, whereas in the present invention, a liquid containing multiple types of predetermined bacteria. Also, while the present invention provides a warm bath device that can be used for providing a service with a high health promoting effect, Patent Document 1 does not have the idea of promoting health. Therefore, the plate body of the warm bath device of the present invention is completely different from the tatami in Patent Document 1.

In a preferred embodiment, the aforementioned core member is a material in which liquid including multiple types of predetermined bacteria and activators is impregnated. Multiple types of bacteria in the liquid are obtained by culturing and activating the bacteria.

According to the preferred embodiment, the core member is impregnated with a liquid in which multiple predetermined types of bacteria are cultured and activated. Therefore, in the warm bath device of this embodiment, as the liquid contained in the core member evaporates, the number of bacteria discharged to the outside of the core member can be increased and actively active bacteria can be discharged to the outside of the core member. In this embodiment, a large number of actively active bacteria diffuse outside the warm bath device, so that a number of actively active bacteria are taken into the human body near the warm bath device. As the number of bacteria that are incorporated into the human body is increased and the bacteria is active, it is possible to further expect the effect of the work of these bacteria. Therefore, in the warm bath device in which the core member is impregnated with the activation liquid, a higher health promotion effect can be expected than a warm bath device in which the core member is impregnated with liquid containing bacteria not activated.

Also, the present invention provides a warm bath method using a warm bath device comprising a plate body having a plate-like core member and a sheet-like surface layer member, the core member containing a liquid containing multiple types of predetermined bacteria, the surface layer member having air permeability and covering a surface of the core member, and a heat generating sheet functioning as a heat source and disposed on another surface opposite to the surface of the core member covered with the surface layer member, the method comprising placing the plate body on the heat generating sheet turning the surface of the plate body covered with the surface layer member upward, laying a human body on the surface layer member, and warming the plate body by the heat generating sheet.

According to the present invention, a plate body is placed on a heat generating sheet. A human body is laid on the plate body. The plate body is warmed by the heat generating sheet. According to the warm bath method, it is possible to warm the human body, and promote releasing multiple types of predetermined bacteria out of the warm bath device, and incorporate these bacteria into the human body.

Further, the present invention provides a plate body comprising a plate-like core member containing a liquid containing multiple types of predetermined bacteria, and a surface layer member having air permeability and covering a surface of the core member.

Replacing the ceramic plate in the ceramic plate bath with the plate body of the present invention or combining the plate body of the present invention with the heat generating sheet makes it possible to provide a warm bath service capable of warming a human body and promoting release of multiple types of predetermined bacteria outside of the plate body to take the bacteria into the human body.

### BRIEF DESCRIPTION OF THE DRAWINGS

FIG. 1 is an assembled perspective view showing a conFigureureuration of a warm bath device 10 according to a preferred embodiment of the present invention.

FIG. 2 is a schematic cross-sectional view showing the conFigureuration of the warm bath system 1 including the warm bath device 10.

FIG. 3 is a sectional view showing the structure of the tatami 100 of the warm bath device 10.

FIG. 4 is a front view of the reinforcing member 130 of the tatami 100 of the warm bath device 10.

FIG. 5 is a cross-sectional view showing the conFigureuration of the groove 134 of the reinforcing member 130 of the tatami 100 of the warm bath device 10.

FIG. 6 is a schematic diagram for explaining a warm bath service using the warm bath system 1 including the warm bath device 10.

### PREFERRED EMBODIMENTS OF THE PRESENT INVENTION

The following description will explain preferred embodiments of the present invention with reference to the drawings.

### Preferred Embodiment

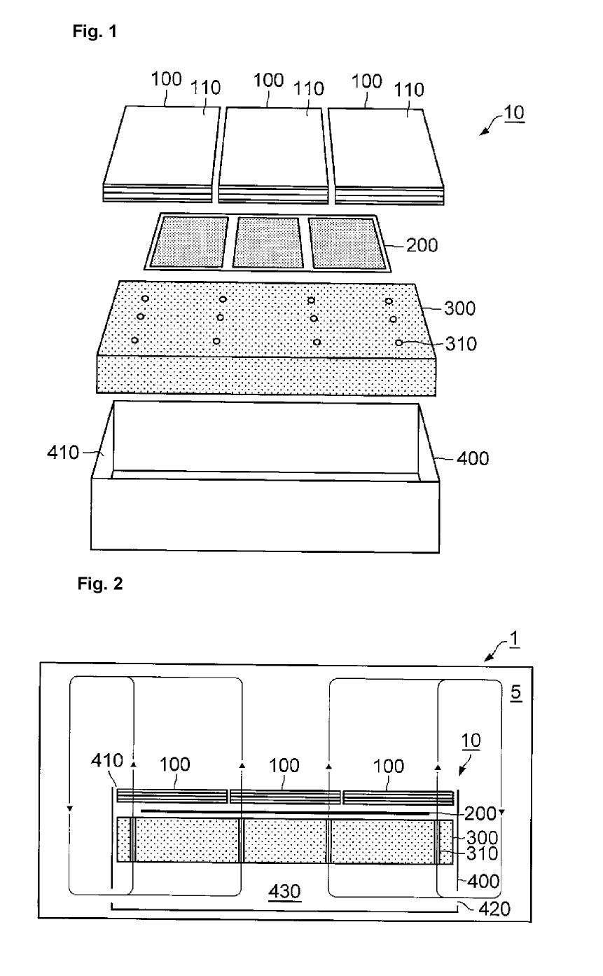

FIG. 1 is an assembled perspective view showing the configuration of a warm bath device 10 according to an embodiment of the present invention. Also, FIG. 2 is a cross-sectional view schematically showing a configuration of a warm bath system 1 including a warm bath device 10 according to the embodiment. The warm bath system 1 is configuration by installing the warm bath device 10 in a space 5 (hereinafter referred to as a service providing space) in a facility that provides a warm bath service.

Warm bath device 10 comprises a tatami 100 which is an example of a plate having a configuration specific to the embodiment, a heat generating sheet 200, a heat insulating member 300, and a housing 400. The user of a warm bath service by warm bath system 1 lies on tatami 100 to subject to the provision of a warm bath service. The configuration of the tatami 100 will be more specifically described later.

The heat generating sheet 200 is a sheet-like member that generates heat and functions as a heat source in the warm bath device 10. Specifically, the heat generating sheet 200 is a heat generating carbon sheet containing a carbonaceous material. Carbonaceous material of the heat generating sheet 200 is, for example, a porous material. The heat generating sheet 200 has air permeability in the thickness direction. The heat generating sheet 200 generates electric power by receiving electric power from an external power source (not shown), and heats the carbonaceous material in the heat generating sheet 200 to emit far infrared rays from the carbonaceous material. The emitted infrared rays heats the heat generating sheet 200 at a predetermined temperature. Temperature of the heat the heat generating sheet 200 occurs, for example, a 47° C.˜60° C. of about centigrade, more preferably a 55° C.

The heat insulating member 300 is a plate-like member having heat insulating properties. In the heat insulating member 300, multiple through holes 310 penetrating in the thickness direction are spaced. Multiple through holes 310 are distributed on the all area of the surface of the heat insulating member 300.

The housing 400 is a box-shaped member having an opening 410 provided in an upper portion thereof. In the housing 400, the heat insulating member 300, heat generating sheet 200 and tatami 100 are stacked in this order from the bottom. More specifically, the heat generation sheet 200 is spaced a slight gap above the heat insulating member 300, tatami 100 while leaving a slight clearance above the heat generating sheet 200 are located. The heat insulating member 300, the heat generation sheet 200 and the tatami 100 are supported by a support mechanism provided in the housing 400 and not shown in such a way that a slight gap is formed between the heat insulating member 300 and the heat generation sheet 200, and a slight gap is also formed between the heating sheet 200 and the tatami 100. The tatami 100 is disposed in the vicinity of the opening 410 in the upper portion of the housing 400. The surface layer member 110 which serves as a table surface of the tatami mat 100 is exposed through the opening 410. That is, the casing 400 is a member that accommodates and supports the tatami 100, the heat generating sheet 200, and the heat insulating member 300 while exposing the surface layer member 110 of the tatami 100 to the outside. Incidentally, the tatami 100 may be in contact with the heating sheet 200, and the heat generating sheet 200 may be in contact with the insulating member 300.

The number of tatami mats 100 that are accommodated in the housing 400 may be a single, or may be an integer of 2 or more number of sheets (s). In FIGS. 1 and 2, side by side three tatami 100 represent examples that are housed in the housing 400. Further, it may be different in dimensions of multiple number of sheets of tatami 100 accommodated in the housing 400. The service provider of the bath system 1 may determines the dimensions of the heat insulating member 300 and the housing 400 based on the dimension and the number of tatami mats 100 to be installed.

The heat insulating member 300 accommodated in the housing 400 is supported by a support mechanism (not shown) of the housing 400 so that the heat insulating member 300 is away from the bottom of the housing 400. Within the lower surface side of the heat insulating member 300 in the housing 400, the space 430 surrounded by the housing 400 and the heat insulating member 300 is formed. An opening 420 penetrating the side surface is provided on the side surface of the housing 400 below the lower surface of the heat insulating member 300. Further, a space 430 in the housing 400 is connected to a space between the heat insulating member 300 disposed with the heat generating sheet 200 and the tatami mat 100 through a through-hole 310 of the heat insulating member 300.

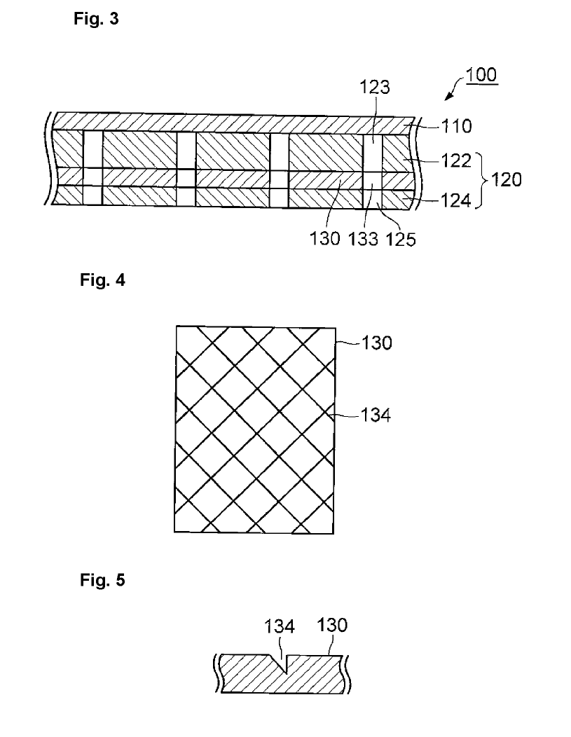

FIG. 3 is a cross section view showing the structure of the tatami mat 100. The tatami mat 100 has a surface layer member 110, a first core member 122, a second core member 124 and a reinforcing member 130. Each of the first core member 122, the second core member 124, and the reinforcing member 130 is a plate-like member. The thickness of the first core member 122 is, for example, 17 mm, the thickness of the second core member 124 is, for example, 3 mm, and the thickness of the reinforcing member 130 is 9 mm, for example. The reinforcing member 130 is sandwiched between the first core member 122 and the second core member 124. The material for forming the first core member 122 and the second core member 124 is, for example, a porous carbon material. When the first core member 122 and the second core member 124 are not distinguished from each other, the core member 122 or 124 is referred to as a core member 120. The core member 120 has cushioning properties. The reinforcing member 130 is a member for reinforcing the strength of the core member 120. The reinforcing member 130 has a stronger rigidity than the core member 120. The material forming the reinforcing member 130 is, for example, wood.

On a surface of the first core member 122 opposite to another surface facing the reinforcing member 130, the sheet-like surface layer member 110 is disposed so as to cover the surface. In other words, one surface of the first core member 122 is covered with the surface layer member 110. The surface layer member 110 has air permeability. The surface layer member 110 may be formed by weaving woven or woven synthetic fibers. That is, the surface layer member 110 may have any air permeability as long as it can function as a tatami table.

In the first core member 122, multiple through holes 123 penetrating in the thickness direction is provided. In the second core member 124, multiple through holes 125 penetrating in the thickness direction is provided. In the reinforcing member 130, multiple through holes 133 penetrating in the thickness direction is provided. Each of the through holes 123, 125 and 133 are distributed on the entire surface of the plate surface of the first core member 122, the second core member 124 and the reinforcing member 130. Then, the through holes 123, 125 and 133 penetrating through is provided such that the openings of the through holes 123, 125 and 133 overlap. The through holes 123, 125 and 133 fulfil a role for efficiently transferring the heat provided from the sheet 200 disposed under the mat 100 to the interior of the tatami mat 100 (more specifically, the interior of the core member 120).

FIG. 4 is a front view of the reinforcing member 130 of the tatami mat 100. Multiple grooves 134 are formed on one surface (specifically, the front surface) of the plate surface of the reinforcing member 130. FIG. 5 is a cross-sectional view showing the configuration of the groove 134 of the reinforcing member 130. As shown in FIG. 5, the groove 134 is a notch having a triangular cross section. In the case where the material of the reinforcing member 130 is wood, the groove 134 is provided so as to cross the fiber of the wood and cut off the fiber. Specifically, as exemplified in FIG. 4, multiple grooves 134 respectively extend from the upper side and the lower side of the reinforcing member 130 to the right side and the left side, and draw oblique grid patterns on the front face of the reinforcing member 130. The groove 134 prevents the warping of the reinforcing member 130 due to the contraction of the fiber, and as a result, plays a role of preventing warping of the tatami 100. In addition, the groove 134 plays a role of increasing the surface area of the reinforcing member 130, and also plays a role of efficiently absorbing and radiating the heat given from the heat generating sheet 200 disposed under the tatami 100. The reinforcing member 130 may be disposed in a posture in which the surface having the groove 134 faces the surface layer member 110 or the surface having the groove 134 is oriented in a direction opposite to the direction in which the surface layer member 110 is disposed (that is, in a posture directed to the heat generating sheet 200 arranged under the tatami mat 100). In FIG. 4, it is not shown through holes 133 extending through the reinforcing member 130.

The core member 120 of the tatami mat 100 of the preferred embodiment is impregnated with a liquid containing multiple types of bacteria determined in advance. This liquid is a liquid containing multiple types of predetermined bacteria and activator, and the predetermined plurality of types of bacteria are activated by culturing a liquid (hereinafter, referred to as “activation liquid”). Specific examples of multiple types of predetermined bacteria include fungi which produce lactic acid (hereinafter simply referred to as lactic acid bacteria), yeast, koji mold (aspergillus), actinomycetes and the like. These bacterial species are said to have useful effects on humans. Hereinafter, multiple types of bacteria included in the activation liquid are referred to as “useful bacteria group”. This useful bacterial group necessarily contains lactic acid bacteria. These useful bacteria are in harmony in the activation liquid.

The detail description will be given with respect to the manufacture of the core member 120. First, the manufacturer of the core member 120 prepares a liquid in which multiple predetermined types of bacteria (specifically, lactic acid bacteria, yeasts, koji molds, actinomycetes, etc.) live together. More specifically, this liquid is made using EM (Effective Micro-organisms) technology. At the same time, the manufacturer of the core member 120 prepares a liquid containing an activating substance suitable for activating multiple predetermined types of bacteria. Specifically, this liquid is a substance containing a lot of iron ions (specifically, divalent iron ions and trivalent iron ions). More specifically, this liquid contains FFC (Ferrous Ferric Chloride: water-soluble dimer iron salt) which is iron which is soluble in water and has the action of both oxidation and reduction. Next, the manufacturer of the core member 120 combines the prepared former liquid and the latter liquid to produce a mixed liquid. Next, the manufacturer of the core member 120 cultivates multiple predetermined types of bacteria (lactic acid bacteria, yeast, aspergillus, radioactive bacteria, etc.) among the produced mixed liquids to activate them. In this way, the manufacturer of the core member 120 generates activation liquid. Then, the manufacturer of the core member 120 immerses the core member 120 in the activation liquid thus produced, and impregnates the core member 120 with this activation liquid. The manufacturer of the core member 120 and the manufacturer of the activation liquid may be different.

The activation liquid in the core member 120 evaporates gradually over time. As the activation liquid evaporates, the useful bacteria group in the core member 120 is gradually released to the outside of the core member 120. The useful bacteria group released to the outside of the core member 120 passes through the surface layer member 110 and the opening 410 and is transported to the outside of the warm bath device 10 and diffuses into the service providing space 5. In the warm bath device 10, since the heat generating sheet 200 is disposed under the tatami mat 100, evaporation of the activation liquid impregnated in the core member 120 is promoted by the heat of the heat generating sheet 200.

As shown in FIG. 2, when the heat generating sheet 200 of the warm bath device 10 generates heat, the convection of the fluid (specifically, air) occurs in the service providing space 5 in the warm bath system 1. The detail description will be given with respect to this matter. The air in the vicinity of the heat generating sheet 200 (specifically, between the tatami mat 100 and the heat insulating member 300) rises as it is heated by the heat of the heat generating sheet 200, passes through the inside of the tatami mat 100, and is discharged to the outer portion of the warm bath device 10 (i.e., service providing space 5) from the opening 420 of the side surface of the housing 400. The air discharged to the outside of the warm bath device 10 is cooled above the service providing space 5, and the cooled air moves below the service providing space 5. The air moved downward in the service providing space 5 passes through the opening 420 of the side surface of the housing 400, and is taken from the outer part of the warm bath device 10 into the space 430 in the warm bath device 10. The air taken into the space 430 in the warm bath device 10 passes through the through hole 310 of the heat insulating member 300 and moves to the vicinity of the heat generating sheet 200. The air moved to the vicinity of the heat generating sheet 200 is heated again by the heat generating sheet 200 and rises. In this way, the air in the warm bath device 10 and the air in the service providing space 5 naturally circulate.

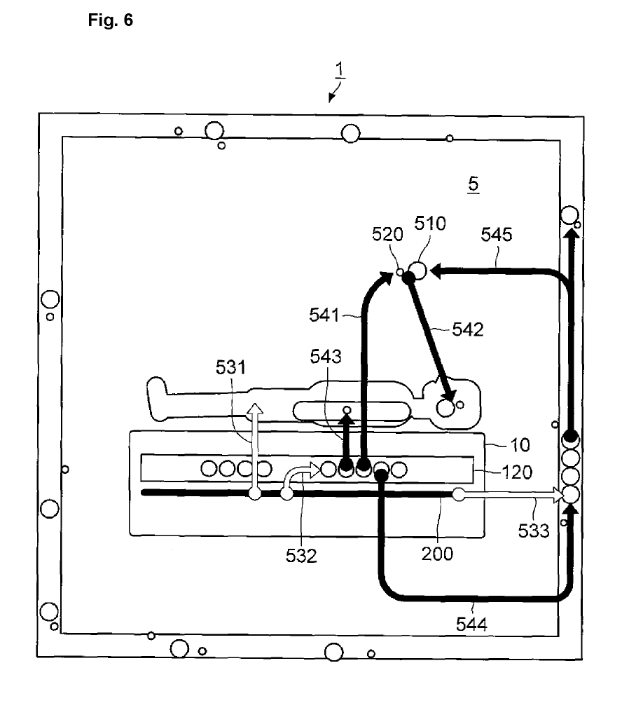

FIG. 6 is a schematic diagram for explaining a warm bath service using the warm bath system 1 of the present embodiment. As shown in FIG. 6, the user lies on the warm bath device 10 installed in the service providing space 5, more precisely, on the tatami mat 100 of the warm bath device 10. That is, in the warm bath system 1, the warm bath device 10 is used like a bed. Since the user of the warm bath system 1 lies on the tatami mat 100 which is softer than the porcelain board, the back, waist and the like are not hurt as compared with the ceramic plate bath.

In the warm bath system 1, a part of the thermal energy of the heat generating sheet 200 passes through the housing 400 as indicated by an arrow 533 in FIG. 6 and is transmitted to the service providing space 5, and is transferred to the floor, the wall or the like forming the service providing space 5. A part of the thermal energy of the heat generating sheet 200 is transmitted to the core member 120 of the tatami mat 100 as shown by an arrow 532 in FIG. 6. A part of the thermal energy of the heat generating sheet 200 passes through the tatami mat 100 and is transmitted to the user on the tatami 100 as indicated by an arrow 531 in FIG. 6. The heat energy transmitted to the user includes not only those due to far infrared rays radiated from the heat generating sheet 200 but also those transmitted to the user by the user's body touching the tatami mat 100 warmed by the heat generating sheet 200. Since the heat energy is transmitted to the user, the core of the body of the user is warmed.

A large circle indicated by reference numeral 510 in FIG. 6 represents the useful bacteria group. In the warm bath system 1, the evaporation of the activation liquid impregnated in the core member 120 is promoted by the thermal energy transmitted to the core member 120, and the useful bacteria group contained in the activation liquid is released to the service providing space 5 as indicated by an arrow 541 in FIG. 6. Further, as the core member 120 is warmed, the growth of the useful bacteria group contained in the activation liquid impregnated in the core member 120 is promoted, and the physiologically active substance is produced in association with their growth. A physiologically active substance produced by a useful bacterial group is a substance simple substance and a group of compounds expected to bring useful physiological action or pharmacological action to humans. Specifically, the physiologically active substance is, for example, vitamins produced by lactic acid bacteria, amino acids produced by the action of koji mold, etc. A small circle indicated by reference numeral 520 in FIG. 6 represents a physiologically active substance. Physiologically active substance produced by the bacterium useful bacteria is also discharged with the evaporation of the activation liquid to the service providing space 5 as indicated by an arrow 541 in FIG. 6. In the warm bath system 1, since the air in the service providing space 5 is naturally circulated by the heat of the heat generating sheet 200, the useful bacteria group and the physiologically active substance diffuse uniformly in the service providing space 5.

In the warm bath system 1, as shown by an arrow 544 in FIG. 6, a part of useful bacteria and physiologically active substances diffused in the service providing space 5 may adhere to the floor, the wall or the like forming the service providing space 5. In addition, in the warm bath system 1, as shown by an arrow 545 in FIG. 6, a part of the useful bacteria group and a part of physiologically active substances adhering to the floor, wall, etc. may diffuse again to the service providing space 5. The useful bacteria group and the physiologically active substance diffused in the service providing space 5 are taken into the body of the user by the respiration or the like of the user in the service providing space 5.

When useful bacteria and physiologically active substance is introduced into the human body, each bacteria of the useful bacteria group introduced into the body produce a physiologically active substance in the human body. At this time, some bacteria in the useful bacteria group decompose extra proteins and the like in the body. Physiologically active substances taken into the body and physiologically active substances produced in the body are absorbed in the body. In addition, components of each bacterium itself (for example, the cell wall of each bacterium) of the useful bacteria group taken into the body are also absorbed in the body. An intestinal effect and the like are expected by the action of each bacterium of the physiologically active substance absorbed in this manner and each bacterium itself of the group of useful bacteria and the useful bacteria group.

It is considered that in the warm bath system 1, as the supply of the warm bath service continues the number of bacteria in the useful bacteria group in the core member 120 decreases with time. This is because the useful bacteria group are released to the outside of the core member 120 with the evaporation of the activation liquid contained in the core member 120, and the released useful bacteria group is taken into the user. Therefore, in the warm bath system 1, it is preferable to periodically replace the core member 120 of the tatami mat 100 with a new article (the core member 120 sufficiently impregnated with the activation liquid). By replacing the core member 120 with a new one, in the warm bath system 1, it is possible to maintain the balance between the number of bacteria in the useful bacteria group and the bacterial species in the service providing space 5 at a predetermined value or more.

As described above, while warming the user's body with the warm bath device 10 of the warm bath system 1 of the present embodiment, releasing multiple predetermined types of bacteria to the outside of the warm bath device 10 and diffusing multiple predetermined types of bacteria in the outside of the warm bath device 10 can be promoted. By using this warm bath device 10, the user's body warms up and multiple predetermined types of bacteria are taken into the user's body.

In the warm bath device 10, bacterial species that are said to provide useful effects (that is, health promotion effects) to humans such as lactic acid bacteria are used as multiple predetermined bacteria. Therefore, by using the warm bath device 10, in addition to improving the flow of blood circulation and lymph due to the warm bathing effect (that is, the effect of warming up the body), the effect of the action of these bacteria (for example, the effect of adjusting the function of the intestines) can be obtained, and a high health promotion effect can be obtained as compared with a simple warm bath effect. The state in which the flow of blood and lymph is improved and the function of the internal organs is improved due to the intestinal effect in this way is expressed in Oriental medicine as “a state of good human circulation”.

Further, the core member 120 of the tatami mat 100 in the warm bath device 10 is impregnated with a liquid containing multiple types of bacteria and activator predetermined in which the bacteria are activated by culturing. In the warm bath device 10, with the evaporation of the liquid contained in the core member 120, the number of bacteria released to the outside of the core member 120 is increased, and actively activated bacteria is released to the outside of the member 120. Since many active bacteria diffuse out of the warm bath device 10, in the warm bath system 1, a large number of active bacteria are taken into the body of the user. As the number of the bacteria incorporated in the body of the user increases and the bacteria incorporated actively act, it is more expected to be effective by the action of bacteria. Therefore, in the warm bath device 10 in which the core member 120 is impregnated with the activation liquid, a higher health benefits is obtained than a warm bath device in which the core member is impregnated with the liquid containing the bacteria not activated.

Also, in the warm bath system 1, a tatami mat 100 is provided as an example of a plate body. In the warm bath system 1, the user lies on the tatami mat 100 which is softer than the ceramic board or the like. Therefore, in the warm bath system 1, it is possible to provide a warm bath service without burdening the back, waist, etc. of the user.

Also, the warm bath system 1, it is possible to expect a high health benefits regardless life or death of the useful bacteria group contained in the core member 120 of the tatami mat 100. This is because if living bacteria of the useful bacteria group are taken into the body, it is expected that the bacteria taken in the body generates a physiologically active substance, and the generated physiologically active substance is absorbed by the human body. This is also because if dead bacteria of the useful bacteria group are taken into the body, it is expected that components of the bacteria itself taken in the body is absorbed by the human body. Further, if each bacteria of the useful bacteria group is living, the each bacterium generates a physiologically active substance. Therefore, if the number of living bacteria is larger, it is possible to expect a higher health benefits. Further, as each bacteria of useful bacteria group in activation liquid is not sterilized when impregnating the core member 100 with the activation liquid, it is possible to suppress an increase in the cost of sterilization of tatami 100, the bacteria workings effect can be obtained at the maximum level to maximize the health benefits.

### The Other Preferred Embodiment

Having described an embodiment of the present invention, other embodiments of the present invention are to be carried out, for example, as follows.

(1) The warm bath device 10 of the embodiment has tatami mat 10 as an example of the plate body. This is because the tatami mat 100 is most suitable one as a plate body of the warm bath device 10. However, plate body of a warm bath device 10 is not restricted to the tatami mat. That is, a plate body of the warm bath device 10 may be a plate body having a plate-like core member containing a liquid containing multiple types of predetermined bacteria and a sheet-like surface layer member having air permeability and covering the surface of the core member.
(2) In the warm bath device 10 of the embodiment, the tatami mat 100 includes a reinforcing member 130. However, the tatami mat may not include a reinforcing member 130. Further, tatami mat 100 includes multiple core members 120 (specifically, the first core member 122 and the second core member 124). However, the tatami mat, only to have more than one core member 120. The reinforcing member 130 is sandwiched between the first core member 122 and the second core member 124. However, the reinforcing member may not be sandwiched by multiple core members. For example, a tatami mat may have a single core member and a single reinforcing member such that the reinforcing member is placed on a surface of the core member opposite to another surface of the core member facing the surface layer member. Further, the tatami mat is not limited to a structure in which the reinforcing member is disposed on the side opposite to the facing surface of the surface layer member of the core member. There may be another structure in which the reinforcing member is disposed between the core member and the surface layer member. Since multiple through holes penetrating in the thickness direction are provided in the reinforcing member, a group of useful bacteria in the core member is discharged to the outside of the tatami mat via the through holes of the reinforcing member and the surface layer member.
(3) The size of the tatami mat 100 need not be the size of a general tatami mat (910 mm×1820 mm). Further, the size of the tatami mat 100 is not limited to one tatami mat, but may be, for example, half tatami size.
(4) In the aforementioned preferred embodiment, the core member 120 of the tatami mat 100 is impregnated with the activation liquid. However, the core member may be a member which has been sprayed with the activation liquid. The activation liquid is included in the core member by spraying the activation liquid. The core member may be a member which has been impregnated with a liquid containing multiple types of predetermined bacteria which have not been activated by culturing (specifically liquid obtained by using EM techniques), or a member sprayed with the liquid. That is, the core member may be a member containing a liquid containing multiple types of bacteria determined in advance. Also, the core member may be a member impregnated with activation liquid by spraying the liquid. When the content of activation liquid in the core member is lowered, the core member may be supplemented with activation liquid (in other words, useful bacteria) by spraying the core member with activation liquid.
(5) In the warm bath system 1 as one embodiment, in order to maintain the balance between the number of bacteria of the useful bacteria group and the bacterial species in the service providing space 5, it is recommended to periodically replace the tatami mat 100 with a new one. In conjunction therewith, in the warm bath system 1, the activation liquid may be periodically sprayed to the service providing space 5.
(6) In the aforementioned preferred embodiment, material of the core member 120 of the tatami mat 100 is carbonaceous porous material. This is because it is suitable for inclusion of the activation liquid containing useful bacteria in the core member 120. However, material for forming the core member is not limited to carbonaceous porous material. Material for forming the core member may be material capable of taking therein the activation liquid containing useful bacteria group from the outside.
(7) In the aforementioned preferred embodiment, the first core member 122 and the second core member 124 in the tatami 100 have multiple through holes 123 and 125. However, the core member of the tatami mat need not have through holes. There is concern that the tatami mat which does not have a through hole penetrating through the core member has a lower efficiency of heat conduction to the inside of the core member as compared with a tatami mat which has a through hole penetrating the core member. Nevertheless, the heat can still be conducted to the core member. In the first embodiment, the reinforcing member 130 of the tatami mat 100 has multiple grooves 134. However, the reinforcing member 130 does not have to have such a groove. There is a concern that a tatami mat without a groove in the reinforcing member may lower heat absorption and radiation efficiency given as compared with a tatami mat having a groove in the reinforcing member. Nevertheless, a tatami mat without a groove can absorb heat given and radiate the heat.
(8) In the aforementioned preferred embodiment, the warm bath device 10 includes the tatami mat 100, the heat generating sheet 200, the heat insulating member 300, and the housing 400. However, it is enough for a warm bath device to comprise at least a plate body (specifically, tatami mat) and a sheet-like surface layer member, the plate body including a plate-like core member containing liquid containing multiple types of predetermined bacteria, and the surface layer member having air permeability and covering one surface of the core member, and a heat generating sheet functioning as a heat source and disposed on another surface opposite to the surface of the core member covered with the surface layer member. This is because, if a warm bath device comprising the plate body (specifically, tatami mat) and the heat generating sheet can warm the human body and promote releasing multiple types of predetermined bacteria to the outside of the device and diffusion of the bacteria in the outside of the device.
(9) Provided to the market is not only the warm bath system 1 of the aforementioned preferred embodiment but also the warm bath device 10 alone for use in the warm bath system 1. Because installing the warm bath device 10 in the space for providing a warm bath service makes it possible to construct a warm bath system 1 easily. Further, not only a warm bath device 10, but also a plate member (tatami mat 100 specifically) used in the warm bath device 10 may be provided to the market alone. Replacing ceramic plate in ceramic plate bath with the plate body or combining the heat generating sheet and the plate body makes it possible to provide warm bath service for warming the human body and promoting release of multiple types of predetermined bacteria from the plate body and introduce the bacteria into the human body. The plate member, for example, may be used as building materials such as wall materials. For example, the plate body may be used as the wall material forming the service providing space 5 of the warm bath system 1.
(10) Also, a warm bath service may be provided by a warm bath method using a warm bath device comprising a plate body having a plate-like core member and a sheet-like surface layer member, the core member containing a liquid containing multiple types of predetermined bacteria, the surface layer member having air permeability and covering a surface of the core member, and a heat generating sheet functioning as a heat source and disposed on another surface opposite to the surface of the core member covered with the surface layer member, the method comprising placing the plate body on the heat generating sheet turning the surface of the plate body covered with the surface layer member upward, laying a human on the surface layer member, and warming the plate body by the heat generating sheet. In this warm bath method, either laying a human body on the surface layer member or heating the plate body by the heat generating sheet may be performed first.

### EXPLANATION OF REFERENCES

1 . . . warm bath system, 5 . . . service providing space, 10 . . . warm bath device, 100 . . . tatami, 110 . . . surface layer member, 120 . . . core member, 122 . . . first core member, 124 . . . second core member, 123, 125, 133, 310 . . . through hole, 130 . . . reinforcing member, 134 . . . groove, 200 . . . heat generating sheet, 300 . . . heat insulating member, 400 . . . housing, 410, 420 . . . opening, 430 . . . space, 510 . . . useful bacteria group, 520 . . . physiologically active substance, 531, 532, 533, 541, 542, 543, 544, 545 . . . arrow.

1. A warm bath device comprising:
a plate body having a plate-like core member and a sheet-like surface layer member, said core member containing a liquid containing multiple types of predetermined bacteria, said surface layer member having air permeability and covering a surface of said core member; and
a heat generating sheet functioning as a heat source and disposed on another surface opposite to the surface of the core member covered with the surface layer member.

2. A warm bath device according to claim 1 wherein,
said core member is a material impregnated in a liquid containing multiple types of predetermined bacteria and activator, said plurality of types of bacteria being activated by culturing.

3. A warm bath device according to claim 1 wherein,
said core member is a material sprayed with a liquid containing multiple types of predetermined bacteria and activator, said plurality of types of bacteria being activated by culturing.

4. A warm bath device according to claim 1 wherein,
said core member comprises a porous carbonaceous material having multiple holes penetrating in the thickness direction.

5. A warm bath device according to claim 1 wherein,
said plate body further comprises a plate-like reinforcing member having multiple holes penetrating in the thickness direction and arranged to cover the core member.

6. A warm bath method using a warm bath device comprising a plate body having a plate-like core member and a sheet-like surface layer member, said core member containing a liquid containing multiple types of predetermined bacteria, said surface layer member having air permeability and covering a surface of said core member, and a heat generating sheet functioning as a heat source and disposed on another surface opposite to the surface of the core member covered with the surface layer member, said method comprising:
placing said plate body on the heat generating sheet turning the surface of said plate covered with the surface layer member upward;
laying a human body on said surface layer member, and
warming the plate body by the heat generating sheet.

7. A plate body comprising:
a plate-like core member containing a liquid containing multiple types of predetermined bacteria, and
a surface layer member having air permeability and covering a surface of said core member.
